(19) United States
(12) Patent Application Publication
(10) Pub. No.: US 2009/0256027 A1
(43) Pub. Date: Oct. 15, 2009

(54) Aerodynamic Noise Reducing Method (Variants) and Low-Noise Structural Element for Operating in a Fluid Medium Stream

(76) Inventors: Victor Feliksovitch Kopiev, Moscow (RU); Mikhail Yurevitch Zaytsev, Moscow Region (RU); Nikolay Nikolaevitch Ostrikov, Moscow (RU); Sergey Anatolevitch Tchernushev, Moscow Region (RU)

Correspondence Address: Ilya Zborovsky, 6 Schoolhouse Way, Dix Hills, NY, 11746, US

(21) Appl. No.: 11/989,977

(22) PCT Filed: Jul. 27, 2006
(86) PCT No.: PCT/RU2006/000402

§ 371 Date: Feb. 2, 2008

(30) Foreign Application Priority Data
Aug. 4, 2005 (RU) 2005124846
Aug. 4, 2005 (RU) 2005124847

(51) Int. Cl. F15D 1/10

(52) U.S. Cl. 244/1 N

(57) ABSTRACT

The invention relates to aerodynamic. The inventive method for reducing the aerodynamic noise generated by separation a medium stream streaming around a structural element surface during the relative motion thereof consists in forming a low-curvature area consisting of at least one continuous section on at least one part of the structural element surface operating beyond the medium stream separation line and in orienting said structural element with respect to the medium stream in such a way that a normal line direction with a structural element surface is close to or coincides with the vector velocity direction of the medium stream on the entire or major part of the area surface. According to the second variant of the method the low-curvature is not formed at the production stage but is determined on the structural element surface of an existing structure using the features of the shape thereof. A low-noise structural element produced by the inventive method is also disclosed. The device also can be developed in such a way that it makes it possible to optimize the use thereof in particular application cases. The aim of the invention is to reduce the aerodynamic noise without deteriorating other aerodynamic characteristics of a structure.

### FIELD OF THE INVENTION

The invention relates to the field of aerodynamics and, in particular, to methods of improving aeroacoustic characteristics of a device by means of action on a fluid medium stream, which streams around a surface of structural elements. The invention can be applied in development and manufacturing of low-noise structural elements of airplanes (for example, supports and wheels of a chassis, supports of a guiding apparatus of an engine), ships and automobiles (for examples, bodies and antennas), heatexchangers of power stations, braces of fans.

### PRIOR ART

Methods of reducing aerodynamic noise, generated by fluid medium stream, which streams around structural elements of a device (for example, airplane) are known, by deviation of an oncoming stream from those structural elements, whose streaming around leads to generation of aerodynamic noise [1-4].

In [1] a low-noise streamliner is proposed, which closes an area of a hinge connection of a brace and a support of a chassis. In [2] as a device for deviating a stream away from the chassis, a gap nozzle is proposed, which must produce an air screen in front of the chassis of airplane. The same idea, which is realized by means of a rigid surface, that deviates during a flight and prevents streaming around of the chassis is used in [3]. In [4], as elements reducing noise of a chassis, partially perforated surfaces are proposed, which deviate a stream of air in the area of a support and wheels of the chassis.

The main disadvantage of the technical solutions [1-4] is a significant change of a nature of streaming out of the device as a whole, which can lead to worsening of its aerodynamic characteristics. Moreover, the use of additional elements which deviate a stream is connected with an increase in weight of the device, complication of its construction, maintenance and repair, and as a result leads to an increase of cost and service expenses.

Methods of improving aerodynamics of fluid medium stream near a flat surface are known, which suggest changing of a microstructure of a surface [5, 6]. However, these methods can not be used for structural elements of a curvilinear, for example cylindrical shape, whose streaming around has a separation nature and which are sources of aerodynamic noise in many devices.

A method of reducing aerodynamic noise generated by a fluid medium stream during streaming around the structural element (rear wing of airplane) is known, in which the reduction of aerodynamic noise is achieved by changing a curvature of an element surface [7]. In accordance with the method [7] the level of noise which is generated by the stream that streams around the structural elements (rear wing), is reduced by changing a curvature of its surface with formation of zone of a smooth curvilinear uninterrupted rounded surface on its side face, which initially has a flat surface. In this process the reduction of noise is achieved by reducing intensity of secondary whirls and elimination of turbulence in the stream adjoining the formed zone.

Method [7] is selected as a prototype of the proposed method.

In the same source [7] a structural element is described (rear wing of airplane) which is formed in accordance with the method-prototype and provides a reduced level of aerodynamic noise during the operation in a fluid medium stream. This structural element is selected as a device-prototype of the proposed low-noise structural element. The structural element [7] includes upper, lower and side surfaces which are streamed around by a fluid medium stream. In the device-prototype the reduction of aerodynamic noise generated by a fluid medium stream during streaming around a structural element is achieved by making on the side surface of the element a zone of a smooth curvilinear uninterrupted rounded surface. This reduces intensity of secondary whirls and eliminates turbulence in the stream adjoining the formed zone.

The disadvantage of the method and the structural element known from [7]—is inefficiency in relation to aerodynamic noise, generated during separation of a fluid medium stream from the curvilinear, for example cylindrical, surface of the structural element which is stream around, and accompanying action on the turbulence of the change of nature of streaming around which can influence the aerodynamic parameters of the structure as a whole.

### DISCLOSURE OF THE INVENTION

An objective of the invention—is to provide a reduction of a level of aerodynamic noise generated during separation of a stream from a curvilinear surface of the structural element which is streamed around, without significant influence on a nature of streaming around and aerodynamic parameters of a structure as a whole.

The solution of this objective is provided by inventions, which form a group, including a method of reduction of aerodynamic noise, generated by a separation of a medium stream which streams around the surface of a structural element during their relative movement, and a low noise structural element for operation in a fluid medium stream which is a product obtained by the proposed method.

The proposed method of reduction of aerodynamic noise can be realized in any of two variants.

First variant of the method resides in that a zone of a reduced curvature is provided at least on a part of a surface of a structural element provided for operation behind a line of separation of a medium stream, which zone contains at least one uninterrupted portion, and the structural element is oriented relative to fluid stream so that over the whole area or a greater part of the area of the zone a direction of a normal line to the surface of the structural element is close to or coincides with a direction of a vector of velocity of a medium stream (claim 1).

In accordance with the first variant, the zone of increased curvature is formed at stages of designing and manufacturing of an article or a structural element.

A second variant of the method resides in that a zone of reduced curvature on a surface of a structural element is determined, which is composed at least one uninterrupted portion, and the structural element is oriented relative to a medium stream so that over a whole area or a greater part of the area of the zone a direction of a normal line to the surface of an element is close to or coincides with a direction of a vector of velocity of the medium stream (claim 5).

In accordance with the second variant the zone of reduced curvature is not formed during manufacturing, but it is determined on the surface of the element of the existing structure by using peculiarities of its geometry, and then the structural element is correspondingly oriented relative to the medium stream.

First variant of the method has developments which allow optimizing of its use to particular cases of its utilization.

The first development resides in that the zone of the reduced curvature is formed as at least one portion of a flat surface (claim 2).

Second development of the method relates to a case of a fluid medium stream which has a nonuniform speed and resides in that the zone of reduced curvature is expanded in a direction of increase of velocity of a fluid medium stream (claim 3).

Third development of the method relates to a structural elements which rotates around an axis (for example, a pneumatic tire of a chassis), and resides in that the zone of reduced curvature is formed by reduction of a curvature of a surface of the structural element in a plane which extends through its axis of rotation (claim 4), or in other words the area of a pneumatic tire which is in contact with the ground is made as flat as possible.

An object of the invention is also a device—a low-noise structural element, comprising a front part of a surface provided for operation in oncoming fluid medium stream, a rear part of a surface provided for operation behind a line of separation of fluid medium stream, and a zone of a surface with a reduced curvature composed at least of one uninterrupted portion, wherein at least one half of an area of the zone is located on a back part of a surface of the structural element, and a direction of normal lines to a surface over a whole area or a greater part of area of the zone of reduced curvature is close to or coincides with a direction of a vector of velocity of oncoming fluid medium stream relative to the structural element (claim 6).

The invention—device also has developments which allow to optimize its use in particular cases.

First development of the device resides in that the zone of reduced curvature can be formed as at least one portion of a flat surface (claim 7).

Second development of the device relates to a case of a fluid medium stream which has nonuniform speed and resides in that the zone of reduced curvature can be formed expanding in a direction of increase of a velocity of a nonuniform fluid medium stream (claim 8).

Third development relates to a structural element which is formed with a possibility of turning around its axis of rotation. In this case the zone of reduced curvature can be formed near a section of a surface of the structural element by a plane extending through its axis of rotation (claim 9).

### BRIEF DESCRIPTION OF THE DRAWINGS

FIGS. 1, 2, 3 illustrate a physical principle on which the proposed group of the inventions are based. FIGS. 4, 5, 6, 7 show examples of realization of the invention for low-noise structural elements.

### BEST VARIANT OF REALIZATION OF INVENTION

The invention is based on a physical principle of reflection of sound waves from a solid surface, which is explained below with the use of concepts of dipole and quadripole sources of noise (M. A. Isakovich “General Acoustics” Moscow, “Nauka” 1973, Chapter 9).

Dipole source of noise has two monopoles located near one another (spherically symmetric pointed sound sources), generating counterphase oscillations of a medium with moment d, while a quadripole source includes two dipoles, whose moments d1 and d2 are equal and directed to opposite sides, so that a sum dipole component of a quadripole source of noise Δd=d1−d2 is equal to zero.

One of important sources of noise of various devices operating in a stream of fluid medium is turbulence which is generated during a separation of a streaming around fluid medium stream from a surface of structural elements. However, a free turbulence is a compensated quadripole source of noise.

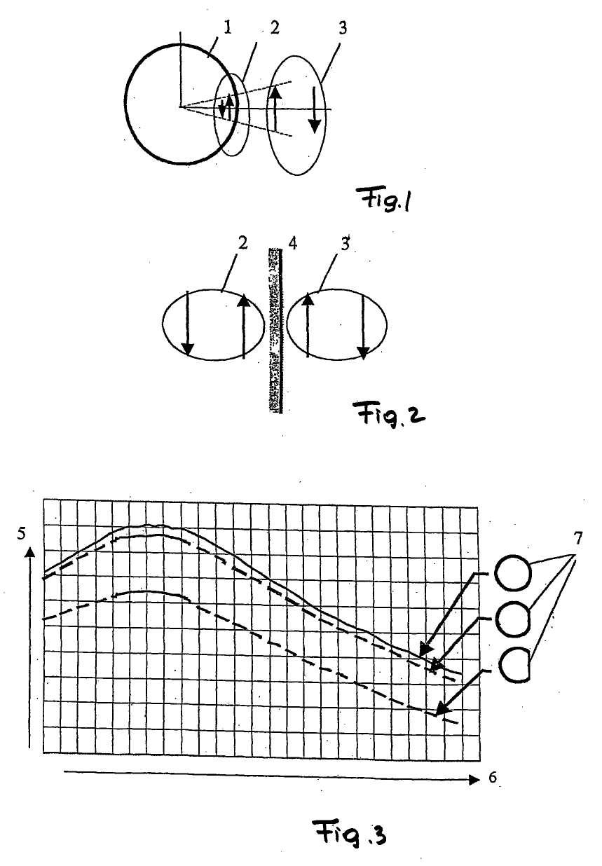

Noise is significantly amplified near a curvilinear solid surface 1 due to appearance of a non-compensated dipole component, which is generated (see FIG. 1) as a result of appearance of a reflection 2 of an initial quadripole 3 from the surface 1. [Experimental Investigation of Azimuthal Structure of Dipole Noise for Rigid Cylinder Inserted in Turbulent Jets, AIAA Paper No. 2004-2927].

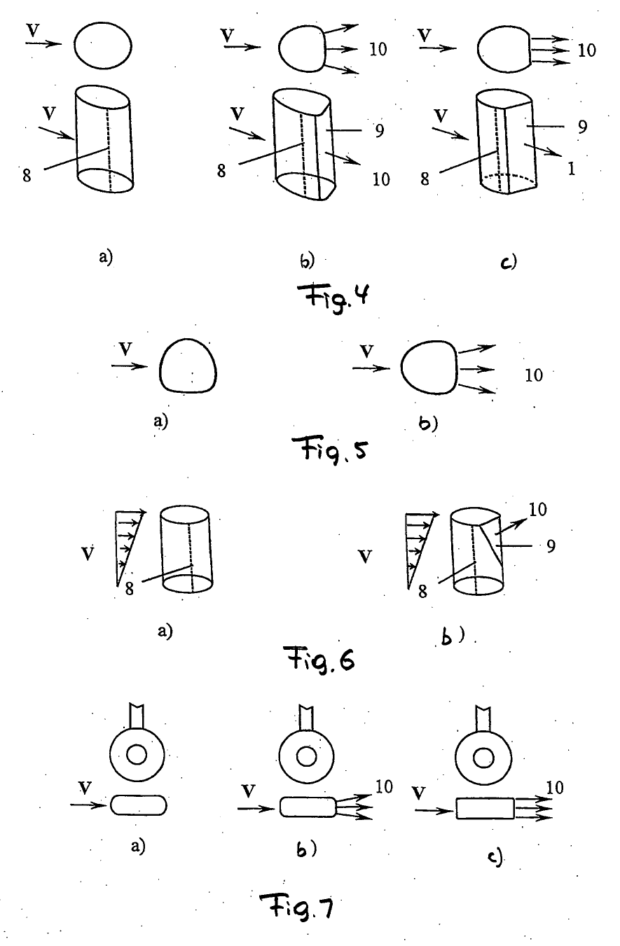

Investigations conducted by authors of the proposed invention showed that with reduction of a curvature of a solid surface, from which a quadripole source of noise is reflected, a non-compensated dipole component of noise is reduced and for a flat surface 4 (see FIG. 2) theoretically completely disappears. Therefore, if from the element of a cylindrical shape operating in a turbulent stream a rear edge is cut off, then the noncompensated dipole component from reflected quadripole sources must reduce.

This non-obvious conclusion was confirmed by several experiments. A noise generated by a transverse streaming around of a cylindrical body with a turbulent stream with a speed of 100 m/set was investigated. Experimentally obtained relationships are shown in FIG. 3, on which 5 identifies a level of a sound pressure (noise), 6-an angle of observation, 7-a cross-section of a body which is streamed around. As a result of the experiments, it was determined (see FIG. 3) that for a cylinder with a flat rear surface a level of noise reduces by a value 27 db in a whole range of angles of observation. Since the change of curvature of the surface of a cylinder during the experiments were performed behind a line of separation of the stream from it, this effect was achieved without a change of average parameters of streaming, and as a result without worsening of other aerodynamic characteristics.

The effect of reduction of noise without significant influence on a nature of streaming around and aerodynamic parameters was maintained during a more significant cutoff of the cylinder, wherein borders of a flat part of the cylinder were located somewhat forwardly of a line of separation determined before performing the cutting off.

The use of the above described principle of reduction of aerodynamics noise is a basis for the proposed method.

The possibilities of realization of the proposed invention are illustrated in FIGS. 4, 5, 6, 7.

FIGS. 4 and 5 show a possibility of utilization of the invention in structures of supports and braces of a front and a main chassis of an airplane, elements of a hydraulic system of the chassis; automobile antennas, FIG. 6—in construction of braces, which hold a casing of a fan, that are stream around by a non-uniform stream which increases toward the periphery, FIG. 7—in a construction of a pneumatic tire of a chassis of an airplane.

FIGS. 4a, 5a, 6a, and 7a show an initial shape and position of corresponding structural elements during their movement relative to a fluid medium.

FIG. 4b shows a shape and a position of corresponding structural elements after formation of a zone of a reduced curvature and orientation of a structural element in accordance with a first variant of the method (claim 1), on FIG. 4c is the same but with a development which provides a formation of a zone of reduced curvature in form of a portion of a flat surface (claim 2).

FIG. 5b shows a cross-section of a structural element, which has on a surface a zone of a reduced curvature and is oriented in a stream of fluid medium in accordance with the second variant of the method (claim 5).

FIG. 6b shows a shape and a position of a corresponding structural element after formation of a zone of reduced curvature and orientation of a structural element in accordance with the first embodiment of the method with developments including the formation of the zone of reduced curvature in form of a portion of a flat surface (claim 2) and an expansion of said zone in a direction of increase of velocity of a nonuniform fluid medium stream (claim 3).

FIG. 7b shows a result of the use of the first variant of the method with consideration of the development providing a reduction of a curvature of a surface in a plane which extends through an axis of rotation of the structural element (claim 4), and FIG. 7c shows the same with consideration of the development providing a formation of a zone of reduced curvature in form of a portion of a flat surface (claims 2 and 4).

FIGS. 4 and 6 show lines 8 of separation of a stream from a surface of structural elements (determined for example in experiments), and a zone 9 of a reduced curvature. The zones 9 are formed (in accordance with first variant of the method) at least on a part of a surface of the element provided for operation behind the line of separation 8, forming their curvature so that the normal lines 10 to the surface of the element in the zone 9 coincide with or are close to a direction of a vector V of a velocity of stream which streams around the element. The closeness here means that a projection of the vector V on the normal line 10 can constitute not more than 0.8 of its module, and the direction of the vector V means a direction of a stream velocity in its oncoming part relative to the structural element.

The lines 8 shown in FIGS. 4 and 6 separate a front and a rear (relative to the vector V of velocity of the oncoming medium stream) parts of the surface of the structural element. The front part of the surface of the element (at the left side of line 8) is provided for operation in an oncoming stream of fluid medium, the rear part of the surface (at the right side of line 8) is provided for operation behind the line of separation of the stream. The zones 9 are located on a back part of the surface of the element, and a direction of the normals 10 to the surface over the whole area or a greater part of the area of the zone 9 is close to or coincides with a direction of the vector V of velocity of oncoming fluid medium stream relative to the structural element.

The zone 9 can be formed uninterrupted and composed of several portions of the surface with reduced curvature, for example portions of a flat surface.

FIG. 4b shows a general case for formation of the zone 9 with reduced curvature on the back part of the structural element.

FIG. 4c shows a case of formation of the zone 9 reduced curvature in form of a portion of a flat surface.

FIG. 6b shows a case of formation of the zone 9 in form of a portion of a flat surface, which expands in a direction of increase of velocity of a nonuniform fluid medium stream.

FIG. 7b and 7c illustrate a case where the structural element is formed with a possibility of turning around its axis of rotation. In this case the zone of reduced curvature, in which a direction of a normal line is close to or coincides with the direction of the vector V, is formed near a section of the surface of a structural element with a plane which extends through its axis of rotation, and is maintained on the back part of the rotating element during any turning of the element. FIG. 7b illustrates a general case of formation of the zone 9 with a reduced curvature of a surface on a rotating structural element, and FIG. 7c shows the same case but with the formation of the zone in form of a flat surface. In the case when the zone 9 is formed on a tire protector, it is formed by several portions which are separated by depressions.

In the case of the structural elements having a more complicated geometry than that shown in FIGS. 4, 5, 6, 7, it is advisable to determine preliminarily the zones of increased intensity of turbulent (quadripole) sources and orientation of the structural element with the zone of reduced curvature on the area of maximum turbulence.

The proposal provides efficient reduction of level of aerodynamic noise which is created by separation of a stream from a streamed-around curvilinear surface. Since it proposes to change a shape of the body predominantly behind the line of the separation, it can be used for creation of new and modernization of existing structures with a minimal influence on a nature of streaming around by a fluid medium of a corresponding structural element and without substantial change of aerodynamic parameters of the structure as a whole.

### INDUSTRIAL APPLICABILITY

The proposed technical solution can be used for reduction of noise of streaming around, for example of such structural elements as supports, braces and elements of a hydraulic system of front and main chassis of an airplane, automobile antennas (FIGS. 4 and 5), braces which hold a casing of a fan streamed around by a nonuniform stream which increases toward a periphery (FIG. 6), and also a pneumatic tire of a chassis of airplanes (FIG. 7).

### Sources of Information

1. EP 1340676, IPC B64C 25/16, B64C 7/00, 2003

2. US 2004104301, IPC B64C 27/22, B64C 7/00, 2004.

3. WO 2004 089743, IPC B64C 25/16, B64C 7/00, 2004.

4. WO 2004 039671, PCT B64C 25/16, B64C 7/00, 2004.

5. RU 2110702, IPC F15D, 1/00, 106, 1/12, 1988

6. RU 2191931, IPC F15D, 1/00, 2002

7. RU 2173284, IPC B64C, 3/50, 23/06, 2001

1. A method of reducing aerodynamic noise generated by a separating medium stream streaming around a surface of a structural element during a relative motion, residing in that, at least on a part of a surface of the structural element provided for operation behind a line of separation of the medium stream, a zone of a reduced curvature is formed, which is composed at least one uninterrupted portion, and the structural element is oriented relative to the fluid stream so that on a whole area or on a greater part of the area of the zone a direction of a normal line to the surface of the structural element is close to or coincides with a direction of a vector of velocity of the medium stream.

2. A method as defined in claim 1, in which the zone of a reduced curvature is formed in form of at least one portion of a flat surface.

3. A method as defined in claim 1, in which the zone of a reduced curvature is expanded in a direction of an increase of velocity of a nonuniform medium stream.

4. A method as defined in claim 1, in which the zone of reduced curvature on a rotating structural element is formed by reducing a curvature of a surface of the structural element in a plane extending through its axis of rotation.

5. A method of reducing aerodynamic noise generated by a separating fluid stream which streams around a surface of a structural element during their relative movement, residing in that a zone of a reduced curvature on a surface of the structural element is determined, which is composed of at least one uninterrupted portion, and the structural element is oriented relative to the medium stream so that on a whole area or a greater part of the area of the zone a direction of a normal line to the surface of the structural element is close to or coincides with a direction of vector of velocity of the medium stream.

6. A low-noise structural element for operation in a stream of a fluid medium, comprising a front part of a surface provided for operation in an oncoming stream of the fluid medium, a back part of a surface provided for operation behind a line of separation of a stream of a fluid medium, and a zone of a surface with a reduced curvature composed of at least of one uninterrupted portion, wherein at least one half of an area of said zone is located on the back part of the surface of the structural element, and a direction of normal lines to the surface over a whole area or a greater part of the area of the zone with reduced curvature is close to or coincides with a direction of a vector of velocity of the oncoming stream of a fluid medium relative to the structural element.

7. A structural element as defined in claim 6, wherein the zone of reduced curvature is formed in form of at least one portion of a flat surface.

8. A structural element as defined in claim 6, wherein the zone of reduced curvature is formed expanding in a direction of increase of velocity of the nonuniform stream of a fluid medium.

9. A structural element as defined in claim 6, wherein it is formed with a possibility of turning relative to its axis of rotation, in which the zone of reduced curvature is formed near a section of the surface of the structural element by a plane extending through its axis of rotation.
